(19) United States
(12) Patent Application Publication
(10) Pub. No.: US 2006/0008393 A1
(43) Pub. Date: Jan. 12, 2006

(54) Pollutant reduction system with adjustable angle injector for injecting pollutant reduction substance

(75) Inventor: Edmund S. Schindler, Fairfield, CT (US)

Correspondence Address: ST. ONGE STEWARD JOHNSTON & REENS, LLC, 986 BEDFORD STREET, STAMFORD, CT, 06905-5619, US

(73) Assignee: Diesel & Combustion Technologies LLC

(21) Appl. No.: 11/175,483

(22) Filed: Jul. 6, 2005

Related U.S. Application Data
(60) Provisional application No. 60/585,675, filed on Jul. 6, 2004.

(51) Int. Cl. B01D 53/34

(52) U.S. Cl. 422/172; 422/168; 422/108

(57) ABSTRACT

A system for reducing an amount of at least one pollutant during combustion of fuel within a boiler having a wall is provided. The system includes at least one injector passing through at least one hole in the wall of the boiler, the injector being adapted to inject at least one pollutant reduction substance into the boiler. The injector is pivotable with respect to the wall of the boiler about at least one axis, such that an angle at which the pollutant reduction substance is injected into the boiler is variable.

### RELATED APPLICATIONS

This patent application claims the benefit of, under Title 35, United States Code, Section 119(e), U.S. Provisional Patent Application No. 60/585,675, filed Jul. 6, 2004.

### FIELD OF THE INVENTION

This invention generally relates to systems and methods for reducing the concentration of pollutants, especially pollutants such as nitrogen oxides (NOₓ), sulfur oxides (SOₓ), heavy metals, particulates and opacity that result from the combustion of carbonaceous fuel, and more specifically to a systems and methods to reduce such pollution components through the injection of various substances.

### BACKGROUND OF THE INVENTION

Many different techniques and compositions have been proposed for chemically reducing the concentration of pollutants that result from the combustion of carbonaceous fuel in furnaces, boilers, and the like. These techniques generally call for adding chemicals, dry or in solution, directly into the combustion zone and/or into the effluent stream after combustion. These chemicals typically either react directly with the pollutants themselves, or create conditions within the boiler, furnace or the like which are favorable to reduced levels of pollutant production.

For example, U.S. Pat. No. 3,900,554 discloses reducing nitrogen monoxide (NO) in a combustion effluent by injecting ammonia, specified ammonia precursors, or their aqueous solutions into the effluent for mixing with the nitrogen monoxide at a temperature within the range of 1600° F. to 2000° F. This reference also suggests the use of reducing agents, such as hydrogen or various hydrocarbons, to permit the effective use of ammonia at effluent temperatures as low as 1300° F. Although the patent suggests staged injection of the ammonia composition, there remains no teaching of the efficacy of injecting distinct compositions at different temperature zones to optimize NOₓ reduction without producing a substantial amount of other pollutants.

U.S. Pat. No. 4,208,386 discloses that, for oxygen-rich effluents, the temperature of the effluent should be in the range of 1300° F. to 2000° F. for reducing the nitrogen oxides concentration using urea, added dry or in aqueous solution. Alkanoic solvents are said to be reducing agents which, like hydrogen, carbon monoxide, etc., enable the effective operating temperature to be lowered to below 1600° F. Disclosed again is the suggestion to inject in increments, but these incremental injections are of the same urea composition and must all be at positions meeting the same temperature and oxygen concentration conditions. The same holds true for U.S. Pat. No. 4,325,924.

U.S. Pat. No. 5,139,754 discloses a process for reducing nitrogen oxides in a combusiton effluent which involves introducing a nitrogenous treatment agent into the effluent under conditions effective to create a treated effluent having reduced nitrogen oxides concentration such that ammonia is present in the treated effluent, and then contacting the treated effluent under conditions effective to reduce the nitrogen oxides in the effluent with a nitrogen oxides reducing catalyst. It is disclosed in one example that the nitrogenous treatment agent is introduced at an effluent temperature of about 1700° F. to about 2100° F. and that the effluent, when contacted with the catalyst, is at a temperature of about 400° F. to about 1000° F.

U.S. Pat. No. 5,165,903 discloses a method and apparatus for reducing SOₓ and NOₓ levels in flue gases generated by the combustion of coal in a boiler in which a selected concentration of urea is introduced downstream of the combustion zone after the temperature has been reduced to the range of 1300° F. to 2000° F., and a sodium-based reagent is introduced into the flue gas stream after further reducing the temperature of the stream to the range of 200° F. to 900° F. Under certain conditions, calcium injection may be employed when the temperature of the flue gas stream is in the range of 200° F. to 1100° F.

U.S. Pat. No. 5,240,689 discloses methods and apparatus for reducing NOₓ in combustion effluent gases which employ a two-stage injection process. NHi precursors (such as liquid-phase urea or ammonium hydroxide, or the like) are injected into the flue gas at temperatures in the range from 1400° F. to 1900° F. in a first injection zone to reduce NO to nitrogen. This step is followed by injecting a peroxyl initiator, such as a hydrocarbon material (for example, methanol), into the flue gas at temperatures less than 1400° F. to oxidize residual NO to NO₂ in a second injection zone.

U.S. Pat. No. 5,443,805 discloses a pollutant reduction technique involving the injection of additives such as ammonia or calcium compounds along with a small amount of hydrocarbon, preferably methane or natural gas, in a relatively high temperature region of the effluent stream for reducing pollutants such as NOₓ and SOₓ. In one example, it is taught that injection is achieved by atomization of a liquid-form additive or additive solution with a small amount of gaseous hydrocarbon, and that the temperature of the effluent into which injection takes place is in the range of 1300° F. to 2100° F.

Thus, while the prior art discloses numerous techniques employing various chemicals injected into furnaces, boilers and the like, one thing that these techniques share in common is that there is a limited optimum range of conditions (such as temperature and/or oxygen concentration) into which the chemicals must be injected for each of the techniques to work properly. However, the location of the area within the furnace, boiler, or the like where optimum conditions exist for injection is typically not static, and can can move for a number of reasons, including load swings, changing fuel, sootblowing, ash deposits on the wall, changing weather, etc. Traditional systems such as those discussed above could not correct for such shifts in position.

U.S. Pat. No. 4,777,024 purports to remedy this deficiency by providing a system for injecting urea, ammonia or other material to reduce emission in a boiler or furnace which adds additional levels of injectors on the side of boiler in order to account for load following or for the moving of the temperature zone of optimum NOₓ reduction. More specifically, U.S. Pat. No. 4,777,024 discloses the use of multiple levels of injection to accommodate movement in the temperature zone of injection. As the temperature swings, the injector levels go into service or come out of service in order to accommodate the temperature changes.

Other known techniques to accommodate for movement in the temperature zone of injection are: (i) to change the urea concentration at each level to match the temperature swings, (ii) to add a chemical to the urea mixture to change the temperature requirement locally, and/or (iii) to employ fixed injection angles at the end of he injectors to allow optimization if the injector was placed such that it missed the optimum injection position. All of these systems, however, disadvantageously require added components, and added boiler penetrations, to optimize their performance. For example, such a prior art system may require three levels of four injectors (i.e., 12 injectors and 12 boiler penetrations) rather than just one level of four injectors (i.e., 4 injectors and 4 boiler penetrations). Obviously, the additional injectors and the additional penetrations involved with the prior art systems can be costly, and assembly or servicing of such systems can be time-consuming.

U.S. Pat. No. 6,190,628 discloses a method and apparatus for optimizing the injecting of NOₓ inhibiting liquid reagent into the flue gas of a utility or industrial type boiler to reduce emissions of NOₓ including a temperature sensor for measuring the boiler flue gas temperature and a conduit for injecting the NOₓ inhibiting reagent into the flue gas at a sensed predetermined temperature range. In order to achieve this, the conduit is moveable back and forth to be inserted into, or withdrawn from, the boiler through a hole in the wall of the boiler. However, while this system may be useful in circumstances where the desired location for injection lies on an imaginary axis passing through the conduit, such that the conduit can be extended axially to the desired location, it is of limited use where the desired location for injection may vary from a position upstream of the injector to a position downstream of the injector, in which circumstances, the conduit could not possibly be inserted to the desired position. Moreover, by extending the conduit relatively far toward the center of the boiler, the conduit is prone to rapid degradation due to the typically high heats encountered.

What is desired, therefore, is a system for reducing an amount of pollutant produced during combustion of fuel within a furnace, boiler or the like via the injection of a pollutant reducing substance, which adjusts for shifts of the position of where optimum conditions exist for injection exist, which requires fewer injectors and fewer penetrations than do known systems, which requires only one level of injectors, and which is less costly and less time-consuming to assemble and service than are known systems.

### SUMMARY OF THE INVENTION

Accordingly, it is an object of the present invention to provide a system for reducing an amount of pollutant produced during combustion of fuel within a furnace, boiler or the like via the injection of a pollutant reducing substance.

Another object of the present invention is to provide a system having the above characteristics and which adjusts for shifts of the position of where optimum conditions exist for injection exist.

A further object of the present invention is to provide a system having the above characteristics and which requires fewer injectors and fewer penetrations than do known systems.

Still another object of the present invention is to provide a system having the above characteristics and which requires only one level of injectors although allowing for more than one level or zone of injectors if such is desired.

Yet a further object of the present invention is to provide a system having the above characteristics and which is less costly and less time-consuming to assemble and service than are known systems.

These and other objects of the present invention are achieved according to one embodiment of the present invention by provision of a system for reducing an amount of at least one pollutant during combustion of fuel within a boiler having a wall. The system includes at least one injector passing through at least one hole in the wall of the boiler, the injector being adapted to inject at least one pollutant reduction substance into the boiler and a pivotable member having two portions pivotable with respect to each other. One of the pivotable members is attached to the wall of the boiler, and the other of the pivotable members is attached to the injector, such that the injector is pivotable with respect to the wall of the boiler about at least one axis, so that an angle at which the pollutant reduction substance is injected into the boiler is variable. An angle adjuster causes the injector to pivot to and remain in any of the angles achievable by the injector, and a controller generates control signals in response to input, the control signals being used to actuate the angle adjuster to pivot the injector to a desired position.

In some embodiments, the axis about which the injector is pivotable is generally horizontal. In some embodiments, the axis about which the injector is pivotable is generally perpendicular to a direction of combustion gas flow within the boiler, such that the injector is pivotable to a position that points downstream with respect to the direction of combustion gas flow and to a position that points upstream with respect to the direction of combustion gas flow. In some embodiments, the injector is pivotable about multiple axes.

In some embodiments, the angle adjuster comprises at least one of the following force transmitting members: a pneumatic linear cylinder, a hydraulic linear cylinder, and an electric motor. In some embodiments, the input comprises manual input. In some embodiments, the system further includes at least one sensor, and the input comprises a signal produced by the sensor in response to a sensed condition. In certain of these embodiments, the sensor comprises a temperature sensor. In some embodiments, the system comprises one of a selective non-catalytic reduction (SNCR) system and a rich reagent injection (RRI) system. In some embodiments, the at least one pollutant reduction substance comprises a fuel additive which reduces bonding of ash to the wall of the boiler.

In accordance with another embodiment of the present invention, a system for reducing an amount of at least one pollutant during combustion of fuel within a boiler having a wall is provided. The system includes at least one injector passing through at least one hole in the wall of the boiler, the injector being adapted to inject at least one pollutant reduction substance into the boiler. The injector is pivotable with respect to the wall of the boiler about at least one axis, such that an angle at which the pollutant reduction substance is injected into the boiler is variable.

In some embodiments, the system further includes a pivotable member having two portions pivotable with respect to each other, wherein one of the pivotable members is attached to the wall of the boiler, and the other of the pivotable members is attached to the injector. In some embodiments, the axis about which the injector is pivotable is generally horizontal. In some embodiments, the axis about which the injector is pivotable is generally perpendicular to a direction of combustion gas flow within the boiler, such that the injector is pivotable to a position that points downstream with respect to the direction of combustion gas flow and to a position that points upstream with respect to the direction of combustion gas flow. In some embodiments, the injector is pivotable about multiple axes.

In some embodiments, the system further includes an angle adjuster for causing the injector to pivot to and remain in any of the angles achievable by the injector. In certain of these embodiments, the angle adjuster comprises at least one of the following force transmitting members: a pneumatic linear cylinder, a hydraulic linear cylinder, and an electric motor.

In some embodiments, the system further includes a controller for generating control signals in response to input, the control signals being used to pivot the injector to a desired position. In certain of these embodiments, the input comprises manual input. In certain embodiments, the system further includes at least one sensor, and wherein the input comprises a signal produced by the sensor in response to a sensed condition. In certain of these embodiments, the sensor comprises a temperature sensor. In some embodiments, the system comprises one of a selective non-catalytic reduction (SNCR) system and a rich reagent injection (RRI) system. In some embodiments, the at least one pollutant reduction substance comprises a fuel additive which reduces bonding of ash to the wall of the boiler.

The invention and its particular features and advantages will become more apparent from the following detailed description considered with reference to the accompanying drawings.

### BRIEF DESCRIPTION OF THE DRAWINGS

FIG. 1 is a cross-sectional view of a schematically illustrated boiler incorporating a system for reducing an amount of pollutant produced during combustion of fuel within a furnace, boiler or the like via the injection of a pollutant reducing substance in accordance with an embodiment of the invention;

FIGS. 2A-2C are cross-sectional views of a schematically illustrated embodiment of a variable angle injector for use with the system illustrated in FIG. 1, showing the variable angle injector in various positions.

### DETAILED DESCRIPTION OF AN EMBODIMENT OF THE INVENTION

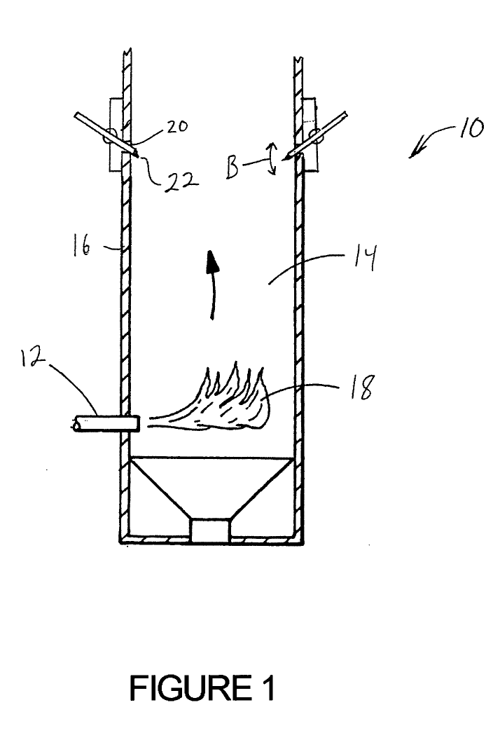

With reference to FIG. 1 a utility or industrial boiler 10 is schematically shown. It should be understood that the term “boiler” is used herein for the sake of simplicity, but that the term is intended to encompass boilers, furnaces or any other like device in which is combusted a fuel. Boiler 10 contains at least one, but typically many, burner 12, located in a combustion chamber 14 defined by a wall 16. In the normal operation of the boiler 10, combustion air and fuel are supplied to the burner 12, and the fuel is burned as shown at 18 in the lower portion of combustion chamber 14. Heating gases flow upwardly through combustion chamber 14, thence out of combustion chamber 14, and typically, but not necessarily to a convection pass or passage, and then successively over and between the tubes of a secondary superheater, a reheater, and a primary superheater and downwardly through a gas passageway. An economizer, air heater, dust collector and stack may be successively located downstream gas flow-wise. Since operation of boilers of the type disclosed herein are extremely well-known, as are the configuration and function of the various above-mentioned components thereof, these aspects of the system are not discussed in detail herein.

Passing through one or more walls 16 of boiler 10, typically, but not necessarily, in or above combustion chamber 14, is at least one opening 20 through each of which passes an injector 22 through which a pollution reduction substance is injected into the boiler 10. Each injector 22 is pivotable about at least one axis (as indicated by double-ended arrow B) such that the angle at which the pollution reduction substance is injected into boiler 10 is variable. A single injector 22 may be provided. However, in most circumstances, a plurality of injectors 22 will be provided, each of the plurality being used to inject the same pollution reduction substances, or some of the plurality being used to inject some substances, while others of the plurality are used to inject other substances.

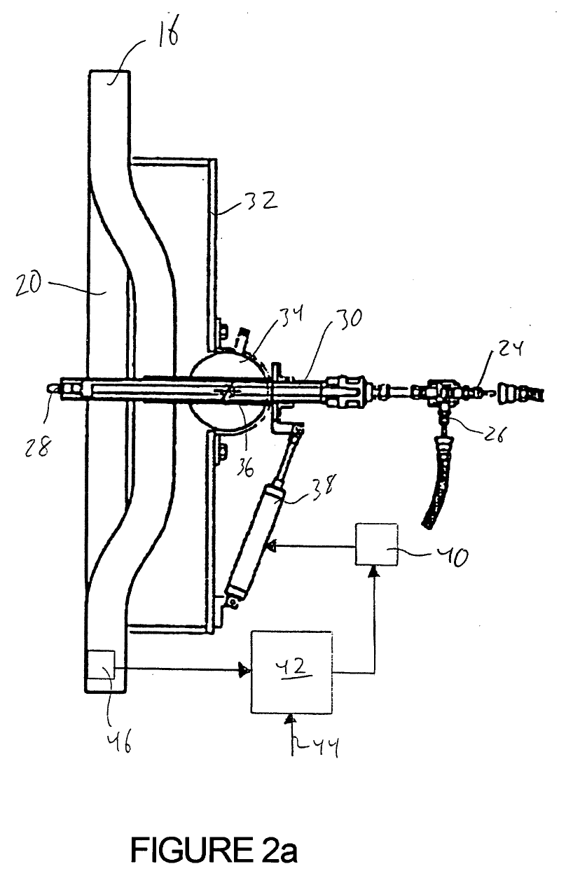

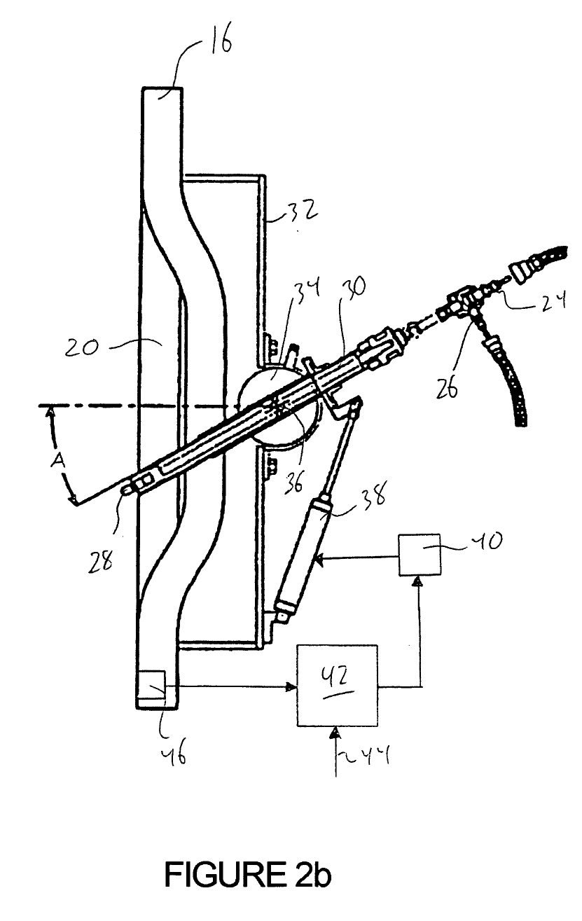

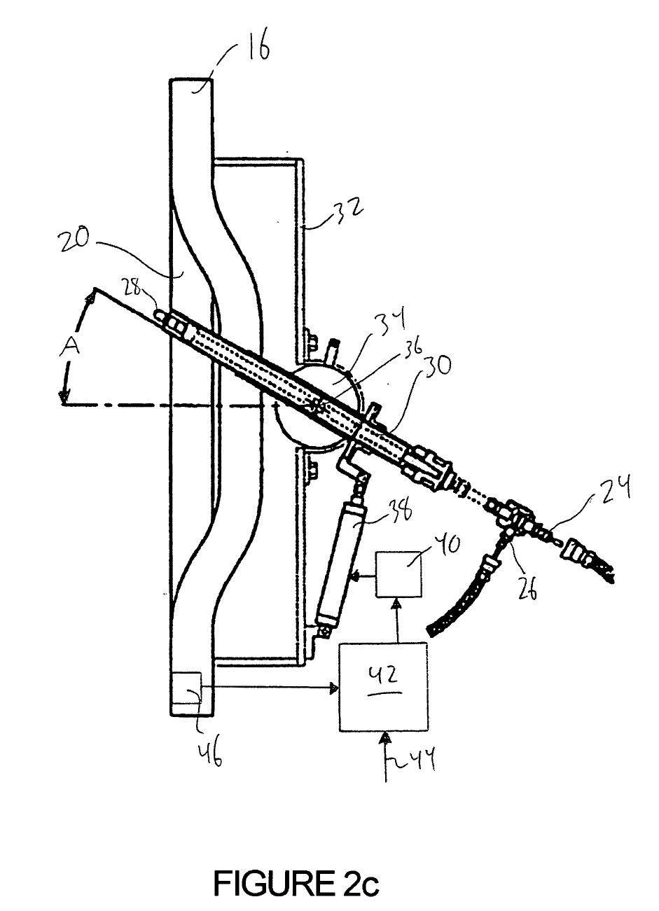

Referring now to FIGS. 2A-2C, injector 22 is shown in more detail. Injector 22 includes at least one inlet 24, 26 at a proximal end thereof through which one or more pollution reduction substances are caused to flow. For example, in the case where injector 22 is used for NOₓ reduction, urea, or a combination of urea and water may be introduced through one of the inlets (inlet 26 for example), while air may be introduced through another inlet (inlet 24 for example). Other examples of pollution reduction substances which may be injected using injector 22 are discussed below.

Injector 22, at its distal end, includes a nozzle 28 through which the pollution reduction substances introduced through inlets 24, 26 are introduced into boiler 10. Nozzle 28 may be an atomizing nozzle, a nozzle that creates a particular spray pattern, or any other currently known or later developed nozzle appropriate for introducing pollution reduction substances into boiler 10. Injector 22 also includes a shaft 30 extending between its proximal and distal ends.

Injector 22 is attached to the wall 16 of boiler 10 by way of a frame 32 attached to wall 16 and a pivotable member 34 having two portions pivotable with respect to each other, one of which is attached to frame 32, and the other of which is attached to shaft 30 of injector 22. In this manner, injector 22 is pivotable with respect to wall 16 of boiler 10 about an axis 36. In the embodiment shown in the Figures, injector 22 is pivotable with respect to wall 16 of boiler 10 about a generally horizontal axis. However, as should be readily apparent to one skilled in the art, injector 22 could just as easily be pivotable with respect to wall 16 of boiler 10 about a generally vertical axis, or about a plurality of axes (e.g., pivotable member 34 could comprise a ball-and-socket joint).

Thus, in the embodiment shown, injector is pivotable from a position generally normal to wall 16 of boiler 10, as shown in FIG. 2A, to a position that points downward (i.e., downstream with respect to the typical direction of flow of combustion gasses or effluent), as shown in FIG. 2B, and to a position that points upward (i.e., upstream with respect to the typical direction of flow of combustion gasses or effluent), as shown in FIG. 2C. The degree to which injector 22 may be angled with respect to wall 16 of boiler 10 (illustrated by angle A in FIGS. 2B and 2C) may be varied from being just slightly angled with respect to normal to being angled significantly with respect to normal. Thus, injector 22 may be positioned along wall 16 of boiler 10 in a position where it is estimated that optimum conditions will exist for the injection of pollution reduction substances. Assuming that the initial estimation is correct, injector would be angled normal to the wall 16 of boiler 10 for optimum injection (FIG. 2A). However, if due to any of a number of circumstances, the optimum conditions for the injection of pollution reduction substances shifts upstream with respect to the position of injector 22, injector could be pivoted to point upstream directly toward the shifted optimum conditions (FIG. 2B). Similarly, if due to any of a number of circumstances, the optimum conditions for the injection of pollution reduction substances shifts downstream with respect to the position of injector 22, injector could be pivoted to point downstream directly toward the shifted optimum conditions (FIG. 2C). The extent to which the optimum conditions shift will dictate the extent to which injector 22 will be angled upstream or downstream.

Injector 22 also includes an angle adjuster 38 for causing injector 22 to move to and remain in any of the angles achievable by injector. Angle adjuster 38 may comprise any of numerous types of force transmitting members, such as a pneumatic linear cylinder (as shown in FIGS. 2A-2C), a hydraulic linear cylinder, an electric motor, etc. When injector 22 is pivotable about more than one axis, more than one angle adjuster 38 may be provided.

Angle adjuster 38 may actuate in response to control signals 40 generated and transmitted thereto by a controller 42. Controller 42 may simply be responsive to manual input 44, such that the angle of injector 22 is controlled manually. However, it is more preferably if controller 42 generate control signals 40 based at least in part upon one or more conditions sensed by one or more sensors 46. However, if desired, manual input 44 can still be used to override control based upon input from sensor 46.

Sensor 46 may comprise a temperature sensor for sensing temperature shifts within boiler 10. The swing in temperature can be measured directly or boiler steam flow could be used generate control signals 40. For example, controller 42 could be programmed in a fixed way, for example, to cause injector 22 to be pivoted to a particular angle at a particular sensed temperature. Of course, much more advanced control strategies could be programmed into controller 42. Inputs to the system may, for example, also include any or all of the following inputs: temperature at the zone of injection, boiler O₂, CO, NOₓ, NH₃ slip, load, water dilution to the urea, atomizing air pressure to change the droplet size to optimize each injector angle, etc. A more sophisticated system may, for example, use a neural net technology to detect an optimum injection angle by using the current load, NOₓ and NH₃ slip measurements or other such measurements and developing a best angle strategy for each angle at each load. At very low load during startup or shutdown the pollution reduction substances (for example urea) can be removed and only water or cooling air used to cool the injector.

In the case of NOₓ reduction, each injector 22 would receive a supply of mixed water and urea, the ratio of which could be changed. At each injector 22, or group of injectors, the atomization air pressure could also be changed to vary the droplet size, and thus change the penetration of the spray.

Pivotable injectors 22 could be used for selective non-catalytic reduction (SNCR) and/or for rich reagent injection (RRI) systems that inject urea and/or ammonia. They could also be used for SO₂, HCL and/or mercury reduction systems that need an optimum temperature zone for reaction. An example of an SO₂ reduction system would be to inject limestone, hydrated lime or calcined lime into the furnace to react with SO₂ to form CaSO₃ and CaSO₄. Each of the three calcium products will capture the sulfur dioxide but are temperature dependent. Limestone, for example, needs the highest temperature because it must first be calcined to release the CO₂. However, if it becomes too hot, it will burn, while if it is too cool, it will not release all CO₂. The temperature optimum window changes in the furnace with load and all the same variables described above, and an optimum system would need to change the injector angle according to the new optimum temperature. The injection of limestone would be as a dry power or a semi dry powder or a wet slurry.

Pivotable injectors 22 could also be used, for example, to spray “fuel additives” directly into the furnace (i.e., the combustion zone 14). For example, chemicals such as magnesium hydroxide that absorb SO₃ and/or create a slip surface on the ash to minimize bonding of the ash to the furnace walls could be injected. Keeping the furnace wall cleaner improves boiler efficiency and can reduce NOₓ. Pivotable injectors 22 could be used to spray such “fuel additives” directly into the optimum location within the furnace, thereby increasing their efficiency and reducing opacity, particulates, etc.

The present invention, therefore, provides a system for reducing an amount of pollutant produced during combustion of fuel within a furnace, boiler or the like via the injection of a pollutant reducing substance, which adjusts for shifts of the position of where optimum conditions exist for injection exist, which requires fewer injectors and fewer penetrations than do known systems, which requires only one level of injectors, and which is less costly and less time-consuming to assemble and service than are known systems

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for reducing an amount of at least one pollutant during combustion of fuel within a boiler having a wall, said system comprising:
at least one injector passing through at least one hole in the wall of the boiler, said injector being adapted to inject at least one pollutant reduction substance into the boiler;
a pivotable member having two portions pivotable with respect to each other, wherein one of the pivotable members is attached to the wall of the boiler, and the other of the pivotable members is attached to said injector, such that said injector is pivotable with respect to the wall of the boiler about at least one axis, so that an angle at which the pollutant reduction substance is injected into the boiler is variable;
an angle adjuster for causing said injector to pivot to and remain in any of the angles achievable by said injector; and
a controller for generating control signals in response to input, the control signals being used to actuate said angle adjuster to pivot said injector to a desired position.

2. The system of claim 1 wherein the axis about which said injector is pivotable is generally horizontal.

3. The system of claim 1 wherein the axis about which said injector is pivotable is generally perpendicular to a direction of combustion gas flow within the boiler, such that said injector is pivotable to a position that points downstream with respect to the direction of combustion gas flow and to a position that points upstream with respect to the direction of combustion gas flow.

4. The system of claim 1 wherein said injector is pivotable about multiple axes.

5. The system of claim 1 wherein said angle adjuster comprises at least one of the following force transmitting members: a pneumatic linear cylinder, a hydraulic linear cylinder, and an electric motor.

6. The system of claim 1 wherein the input comprises manual input.

7. The system of claim 1 further comprising at least one sensor, and wherein the input comprises a signal produced by said sensor in response to a sensed condition.

8. The system of claim 7 wherein said sensor comprises a temperature sensor.

9. The system of claim 1 wherein said system comprises one of a selective non-catalytic reduction (SNCR) system and a rich reagent injection (RRI) system.

10. The system of claim 1 wherein said at least one pollutant reduction substance comprises a fuel additive which reduces bonding of ash to the wall of the boiler.

11. A system for reducing an amount of at least one pollutant during combustion of fuel within a boiler having a wall, said system comprising:
at least one injector passing through at least one hole in the wall of the boiler, said injector being adapted to inject at least one pollutant reduction substance into the boiler; and
wherein said injector is pivotable with respect to the wall of the boiler about at least one axis, such that an angle at which the pollutant reduction substance is injected into the boiler is variable.

12. The system of claim 11 further comprising a pivotable member having two portions pivotable with respect to each other, wherein one of the pivotable members is attached to the wall of the boiler, and the other of the pivotable members is attached to said injector.

13. The system of claim 11 wherein the axis about which said injector is pivotable is generally horizontal.

14. The system of claim 11 wherein the axis about which said injector is pivotable is generally perpendicular to a direction of combustion gas flow within the boiler, such that said injector is pivotable to a position that points downstream with respect to the direction of combustion gas flow and to a position that points upstream with respect to the direction of combustion gas flow.

15. The system of claim 11 wherein said injector is pivotable about multiple axes.

16. The system of claim 11 further comprising an angle adjuster for causing said injector to pivot to and remain in any of the angles achievable by said injector.

17. The system of claim 16 wherein said angle adjuster comprises at least one of the following force transmitting members: a pneumatic linear cylinder, a hydraulic linear cylinder, and an electric motor.

18. The system of claim 11 further comprising a controller for generating control signals in response to input, the control signals being used to pivot said injector to a desired position.

19. The system of claim 18 wherein the input comprises manual input.

20. The system of claim 18 further comprising at least one sensor, and wherein the input comprises a signal produced by said sensor in response to a sensed condition.

21. The system of claim 20 wherein said sensor comprises a temperature sensor.

22. The system of claim 11 wherein said system comprises one of a selective non-catalytic reduction (SNCR) system and a rich reagent injection (RRI) system.

23. The system of claim 11 wherein said at least one pollutant reduction substance comprises a fuel additive which reduces bonding of ash to the wall of the boiler.
